(19) United States
(12) Patent Application Publication
(10) Pub. No.: US 2024/0152723 A1
(43) Pub. Date: May 9, 2024

(54) HUMAN-SYSTEM AIs

(71) Applicant: NORTHROP GRUMMAN SYSTEMS CORPORATION, FALLS CHURCH, VA (US)

(72) Inventors: Harriss C.N. Ganey, Melbourne, FL (US); Amanda Muller, Arlington, VA (US); Matthew Davis, Melbourne, FL (US)

(21) Appl. No.: 18/053,819

(22) Filed: Nov. 9, 2022

(51) Int. Cl. G06N 3/00

(52) U.S. Cl. CPC G06N 3/004

(57) ABSTRACT

An architecture that includes a human, a human AI agent designed to understand and interact with the human, a system, and a system AI agent designed to understand and interact with the system. The human AI agent and the system AI agent are configured to be in communication with each other in a manner so that the human AI agent learns about the system and the system AI agent learns about the human so as to optimize an interaction between the human and the system. The human AI agent and the system AI agent are configured so that the human AI agent learns about the system and the system AI agent learns about the human during a set up process before the architecture is put in operation and during the operation of the architecture.

### BACKGROUND

### Field

This disclosure relates generally to an integrated human/AI interface and a system/AI interface and, more particularly, to an integrated human/AI interface and a system/AI interface, where an AI designed for a human and an AI designed for a system interact with each other so that human AI learns about the system and the system AI learns about the human.

### Discussion of the Related Art

Artificial intelligence (AI) employs interactive computer systems that perform a function or task that normally requires human intelligence, such as visual perception, speech recognition, decision-making, etc., and is known to be used as part of various systems to either assist humans or replace humans. Known AIs interface or interact with humans in different ways. Some AIs gather data on humans to be used for various predictive activities, for example, marketing, whereas other AIs are intended to be inherent to the particular system and the human is ancillary to that system. For most AI enhanced systems that interact with humans, there is a single instance/layer of AI interfacing with the human. Typically, these are system-oriented AIs that are not geared toward interfacing directly with the human. In other words, the AI is designed for the system and not the human. This has led to concerns of AIs and humans doing unexpected things during their interaction, ultimately not providing confidence for the user. For example, in the autonomous vehicle industry, there is a perception that if the AI systems that steer, accelerate and brake the vehicle would need a human in the vehicle to intervene in some situations, the human would adequately do that for those situations. However, the reality is that humans react differently to different things, and thus the confidence that the human will react in a certain desired way may not be reasonable. Therefore, one of the factors that will have a significant effect on the shifting of the human-system balance of task allocation in AI enhanced architectures is how well the system is able to create justified confidence (trust) in the way that it executes its responsibilities.

### SUMMARY

The following discussion discloses and describes an architecture that includes a human, a human AI agent designed to understand and interact with the human, a system, and a system AI agent designed to understand and interact with the system. The human AI agent and the system AI agent are configured to be in communication with each other in a manner so that the human AI agent learns about the system and the system AI agent learns about the human so as to optimize an interaction between the human and the system. The human AI agent and the system AI agent are configured so that the human AI agent learns about the system and the system AI agent learns about the human during a set up process before the architecture is put in operation and during the operation of the architecture. The human interacts with the system directly and through the human AI agent and the system AI agent and the system interacts with the human directly and through the system AI agent and the human AI agent.

Additional features of the disclosure will become apparent from the following description and appended claims, taken in conjunction with the accompanying drawings.

### BRIEF DESCRIPTION OF THE DRAWINGS

FIG. 1 is a block diagram of a known architecture including a human/AI interface and a system;

FIG. 2 is a block diagram of a known architecture including a system/AI interface and a human;

FIG. 3 is a block diagram of the human/AI interface;

FIG. 4 is a block diagram of the system/AI interface;

FIG. 5 is a block diagram of an architecture including the human/AI interface and the system/AI interface in an architecture set up step; and

FIG. 6 is a block diagram of an architecture including the human/AI interface and the system/AI interface in operation.

### DETAILED DESCRIPTION OF THE EMBODIMENTS

The following discussion of the embodiments of the disclosure directed to an integrated human/AI interface and a system/AI interface is merely exemplary in nature, and is in no way intended to limit the disclosure or its applications or uses.

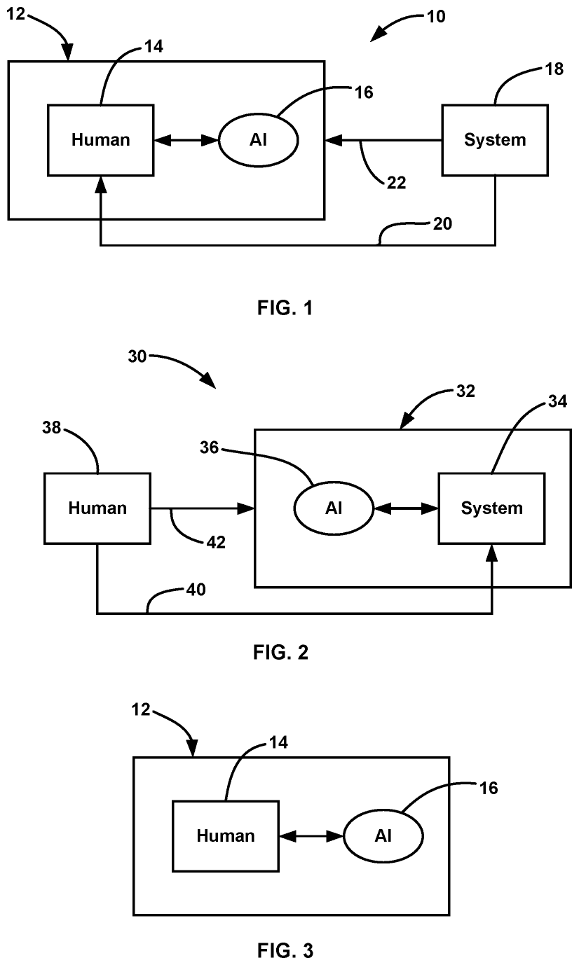

FIG. 1 is a block diagram of a known architecture 10 including a human/AI interface 12 having a human 14 and an AI 16, where the AI 16 is designed and implemented to specifically know about and understand the human 14. The architecture 10 also includes a system 18 that interacts with the human 14 directly represented by line 20 or through the interface 12 represented by line 22, but the AI 16 is not specifically designed to know about or understand the system 18. The system 18 is intended to represent any system that may be suitable to interact with a human who is being enhanced by some type of AI.

FIG. 2 is a block diagram of a known architecture 30 including a system/AI interface 32 having a system 34 and an AI 36, where the AI 36 is designed and implemented to specifically know about and understand the system 34. The architecture 30 also includes a human 38 that interacts with the system 24 directly represented by line 40 or through the interface 32 represented by line 42, but the AI 36 is not specifically designed to know about or understand the human 28. The system 34 is intended to represent any system that may be enhanced by some type of AI and interact with a human.

FIGS. 1 and 2 illustrate the issue discussed above where known AIs are designed for a specific system or the capacities of a human, but not both. Significant effort is spent towards designing AIs for systems to accommodate, and ideally enhance, human use of the system, but often fall short. Conversely, a great deal of time and money is spent selecting and training humans to use these same systems being designed for them.

This disclosure proposes an architecture that includes at least two AIs, where one of the AIs is designed and optimized for a human and one of the AIs is designed and optimized for a particular system. These two AIs are in communication with each other and through that communication each learns about the knowledge that the other has so that the AI for the human learns about the system and the AI for the system learns about the human. When it's time to bring the human and the system together, the two AIs then prepare an interface between the human and the system, ensuring that it is optimal for the specific task to be performed. The AIs would communicate through the same language or protocol, regardless of whether the human and system do, which creates certain efficiencies and make the system overall more effective. Rules between the AIs would be provided, such as who has priority at each decision point, how is the priority determined, what is the importance of each decision, etc. Because of the amount of data and length of exposure that it has had with the human, the human AI also understands patterns of the human when the human really understands a new system. Thus, when introducing a novel system, it can collaborate with the system AI to better identify whether the human is truly ready for operations than current training assessment methodologies. It is noted that the term “AI” as used herein could also be an autonomous agent, and the number of AIs and the number of actual agents (human and/or system) can be greater than two.

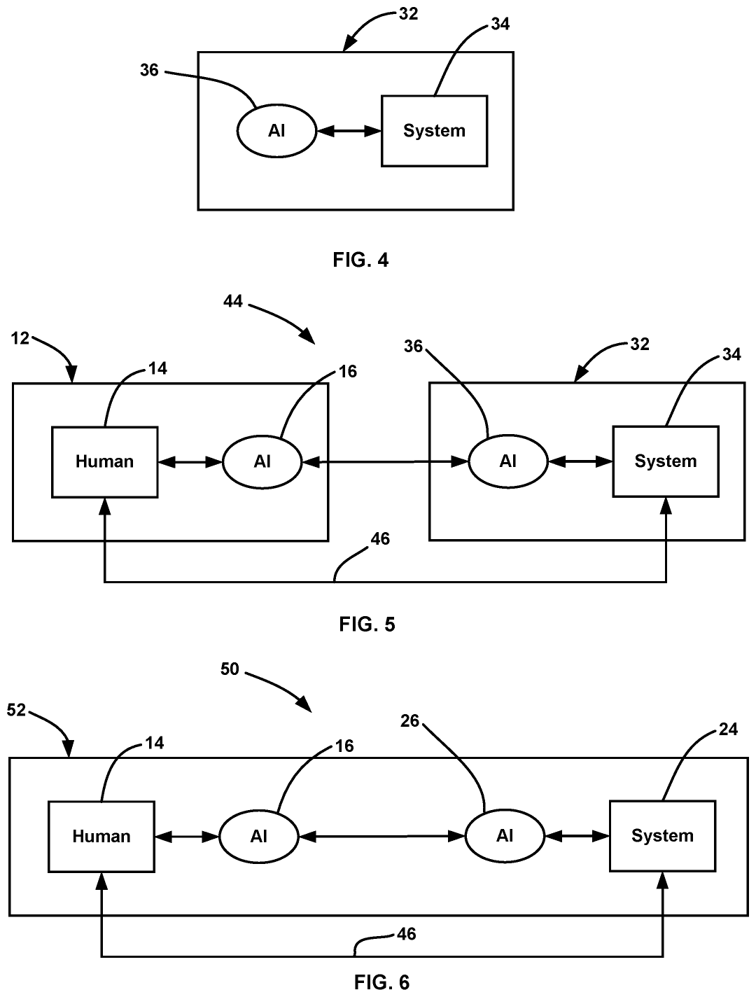

Designing the integration of the AIs as discussed above between a system and a human for a specific architecture starts with providing the interface 12 as shown in FIG. 3 including the human 14 and the AI 16 specifically designed for the human 14 and providing the interface 32 shown in FIG. 4 including the system 34 and the AI 36 specifically designed for the system 34. The two AIs 16 and 36 are brought into communication with other as illustrated by architecture 44 shown in FIG. 5 as a set up step for the final architecture. The AI 16 understands the human 14 in detail and can provide all of that information to the AI 36, and the AI 36 understands the system 34 in detail and can provide all of that information to the AI 16. The AIs 16 and 36 exchange and analyze information so that they can together identify the abilities and limitations of the human 14 and the system 34 and optimize the interactions between the human 14 and the system 34 to achieve a desirable outcome. Interaction between the human 14 and the system 34 represented by line 46 during the set up step can also be used by the AIs 16 and 36 for achieving the desired outcome.

Once the AIs 16 and 36 coordinate and optimize the interaction between the human 14 and the system 34 as a set up step, they continue to coordinate and optimize and cycle contingencies during the interaction between the human 14 and the system 24 while the particular architecture is in operation so as to optimize the architecture for different environments and scenarios. This is illustrated by architecture 50 in FIG. 6 where the human 14, the AI 16, the system 34 and the AI 36 are combined as a single interface 52.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. An architecture comprising:
a human;
a human artificial intelligence (AI) agent designed to understand and interact with the human;
a system; and
a system AI agent designed to understand and interact with the system, wherein the human AI agent and the system AI agent are configured to be in communication with each other in a manner so that the human AI agent learns about the system and the system AI agent learns about the human so as to optimize an interaction between the human and the system.

2. The architecture according to claim 1 wherein the human AI agent and the system AI agent are configured so that the human AI agent learns about the system and the system AI agent learns about the human during a set up process before the architecture is put in operation.

3. The architecture according to claim 2 wherein the human AI agent and the system AI agent are configured so that the human AI agent learns about the system and the system AI agent learns about the human during the operation of the architecture.

4. The architecture according to claim 3 wherein the human AI agent and the system AI agent cycle contingencies during the interaction between the human and the system while the architecture is in operation so as to optimize the architecture for different environments and scenarios.

5. The architecture according to claim 1 wherein the human AI agent and the system AI agent exchange and analyze information so that they can together identify the abilities and limitations of the human and the system and optimize the interaction between the human and the system to achieve a desirable outcome.

6. The architecture according to claim 1 wherein the human interacts with the system directly and through the human AI agent and the system AI agent and the system interacts with the human directly and through the system AI agent and the human AI agent.

7. A method for providing an architecture comprising:
designing a human artificial intelligence (AI) agent that understands and interacts with a human;
designing a system AI agent that understands and interacts with a system; and
providing a communication between the human AI agent and the system AI agent so that the human AI agent learns about the system and the system AI agent learns about the human so as to optimize an interaction between the human and the system.

8. The method according to claim 7 wherein providing a communication between the human AI agent and the system AI agent causes the human AI agent to learn about the system and the system AI agent to learn about the human during a set up process before the architecture is put in operation.

9. The method according to claim 8 wherein providing a communication between the human AI agent and the system AI agent causes the human AI agent to learn about the system and the system AI agent to learn about the human during the operation of the architecture.

10. The method according to claim 9 wherein providing a communication between the human AI agent and the system AI agent causes the human AI agent and the system AI agent to cycle contingencies during the interaction between the human and the system while the architecture is in operation so as to optimize the architecture for different environments and scenarios.

11. The method according to claim 7 wherein providing a communication between the human AI agent and the system AI agent causes the human AI agent and the system AI agent to exchange and analyze information so that they can together identify the abilities and limitations of the human and the system and optimize the interaction between the human and the system to achieve a desirable outcome.

12. The method according to claim 7 wherein the human interacts with the system directly and through the human AI agent and the system AI agent and the system interacts with the human directly and through the system AI agent and the human AI agent.

13. An architecture comprising:
means for providing a human artificial intelligence (AI) agent that understands and interacts with a human;
means for providing a system AI agent that understands and interacts with a system; and
means for providing a communication between the human AI agent and the system AI agent so that the human AI agent learns about the system and the system AI agent learns about the human so as to optimize an interaction between the human and the system.

14. The architecture according to claim 13 wherein the means for providing a communication between the human AI agent and the system AI agent causes the human AI agent to learn about the system and the system AI agent to learn about the human during a set up process before the architecture is put in operation.

15. The architecture according to claim 14 wherein the means for providing a communication between the human AI agent and the system AI agent causes the human AI agent to learn about the system and the system AI agent to learn about the human during the operation of the architecture.

16. The architecture according to claim 15 wherein the means for providing a communication between the human AI agent and the system AI agent causes the human AI agent and the system AI agent to cycle contingencies during the interaction between the human and the system while the architecture is in operation so as to optimize the architecture for different environments and scenarios.

17. The architecture according to claim 13 wherein the means for providing a communication between the human AI agent and the system AI agent causes the human AI agent and the system AI agent to exchange and analyze information so that they can together identify the abilities and limitations of the human and the system and optimize the interaction between the human and the system to achieve a desirable outcome.

18. The architecture according to claim 13 wherein the human interacts with the system directly and through the human AI agent and the system AI agent and the system interacts with the human directly and through the system AI agent and the human AI agent.
